(19) United States
(12) Patent Application Publication
(10) Pub. No.: US 2009/0028318 A1
(43) Pub. Date: Jan. 29, 2009

(54) LOCATION-BASED CALL ROUTING

(76) Inventors: Kulvir Singh Bhogal, Forth Worth, TX (US); Gregory Jensen Boss, American Fork, UT (US); Rick Allen Hamilton, II, Charlottesville, VA (US); Alexandre Polozoff, Bloomington, IL (US); Keith Raymond Walker, Austin, TX (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(21) Appl. No.: 11/782,986

(22) Filed: Jul. 25, 2007

(51) Int. Cl. H04M 3/54

(52) U.S. Cl. 379/211.02

(57) ABSTRACT

A method and implementing computer system are provided in which users are enabled to create a database listing areas in which the user may be at any given moment and corresponding phone numbers to which calls directed to the user's phone number are re-routed if the user is in any of the designated areas when an incoming call is placed. In an exemplary embodiment, a global positioning system is implemented as a geographic locating device to determine the user's location at any time, and a routing server database is implemented and accessed to match the user's current location to one or more user-designated telephone numbers in an area proximate to the user's current location.

### FIELD OF THE INVENTION

The present invention relates generally to information processing systems and more particularly to a methodology and implementation for enabling telephone call routing.

### BACKGROUND OF THE INVENTION

In today's mobile world, many individuals have multiple phone lines at which they can be reached. For example, a given individual might have a different phone line at which they can be reached depending upon their location at any given time of the day. However, to have calls forwarded to selected numbers, the user is required to input the number to which subsequent calls are to be forwarded. In order for a person to have a call routed that was placed to a proxy phone number and forwarded to a specific number, an individual must manually notify the forwarding service about the individual's location and forwarding number. In many situations today, users do not have the time to continually input forwarded numbers as they move from one location to another during the day.

Moreover, users may wish to have calls made to a user's mobile number transferred to a land-line or office phone in order to reduce the number of mobile minutes used and also to take advantage of other features such as conference calling and improved audio in areas served by poor cellular coverage.

Thus there is a need for an improved methodology and implementing call-forwarding system which provides for automatic forwarding of telephone calls to phones in an area or office where a user happens to be at any given moment when a call is placed to the user.

### SUMMARY OF THE INVENTION

A method, medium and implementing computer system are provided in which users are enabled to create records in a database listing areas in which the user may be at any given moment and corresponding phone numbers to which calls directed to the user's mobile number, for example, are re-routed if the user is in any of the designated areas when an incoming call is placed. Users are enabled to have their personal location information automatically reported to a call routing service such that when subsequent calls to the individual are placed, the individuals current location is determined and the calls are automatically routed to a designated user-selected telephone number proximate to the individual's current location. In an exemplary embodiment, a global positioning system is implemented to determine the user's location at any time, and a routing server database is implemented and accessed to match the user's current location to one or more user-designated telephone numbers in an area proximate to the user's current location.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is a block diagram showing several of the major components of a user mobile device in accordance with the present invention;

FIG. 3 is an exemplary location database which may be implemented in accordance with the present invention;

FIG. 4 is an exemplary routing instruction listing which may be specified by a user in accordance with one embodiment of the present invention; and

FIG. 5 is a flow chart illustrating an exemplary operation in one embodiment of the present invention.

### DETAILED DESCRIPTION

The various methods discussed herein may be implemented within a typical computer system which includes processing means, memory, updateable storage, input means and display means, in combination with a location-determining system and communication means for communicating information between individual user systems and a central server system accessible by users of the system. It is noted that although the exemplary embodiment is explained using a GPS locating system implemented within a mobile phone device, the location of the user may be determined by one of many available location-determining systems, devices and methods, including but not limited to a stand-alone global positioning system device, or RFID, WiFi, mote, or mobile phone triangulation. Since the individual components of a computer system which may be used to implement the computer functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention.

In general, a user of a call routing service with proxy phone number (e.g. 512-555-5555) provides call routing information to their service provider's server via a web site or other management interface. For example, the user may stipulate the following routing instruction database details for calls placed to the user's mobile phone:
ROUTE TO HOME PHONE: Within 100 feet of N61° 11.0924′ W130° 30.1660′ route call to:
(512) 111-1111
ROUTE TO OFFICE PHONE: Within 100 feet of N71° 11.0924′ W130° 30.1660′ route call to:
(512) 222-2222
ROUTE TO SECOND OFFICE PHONE: Within 100 feet of N71° 21.0924′ W130° 30.1660′ route call to: (512) 333-3333 else route call to CELL PHONE: (512) 444-4444

In a preferred embodiment, the user's specification of locations is selectable in any number of ways such as: at their GPS-enabled device's current location, a map, and selectable defaults based on the user's pre-established contact information with the service provider. As the user or potential receiver of a call roams from location to location, the user's location information is periodically sent to a call routing server. The period of location update would be transmitted on a user-defined or service provider-defined basis. The location information can be gathered, for example, via a GPS-enabled device such as a mobile phone, PDA, laptop computer, GPS navigation unit, or through other location based services, and sent to the server accordingly.

When a call is placed to the proxy phone number (e.g. 512-555-5555), the call routing service determines where to route a call, based on last known location of the called party as gathered from the location data of the called party. Based on the data gathered, the call is routed to the appropriate called party at the specified number. It is important to note that the invention works for altitudes also. Accordingly, when an individual is in a multi-story building, the user can have calls routed to different phone numbers for office locations where the called party might be located at as determined via information provided by the user's GPS-enabled device. This requires the GPS-enabled device to be able to report altitude, such as by deriving from the speed of the GPS signal, or by an embedded altimeter.

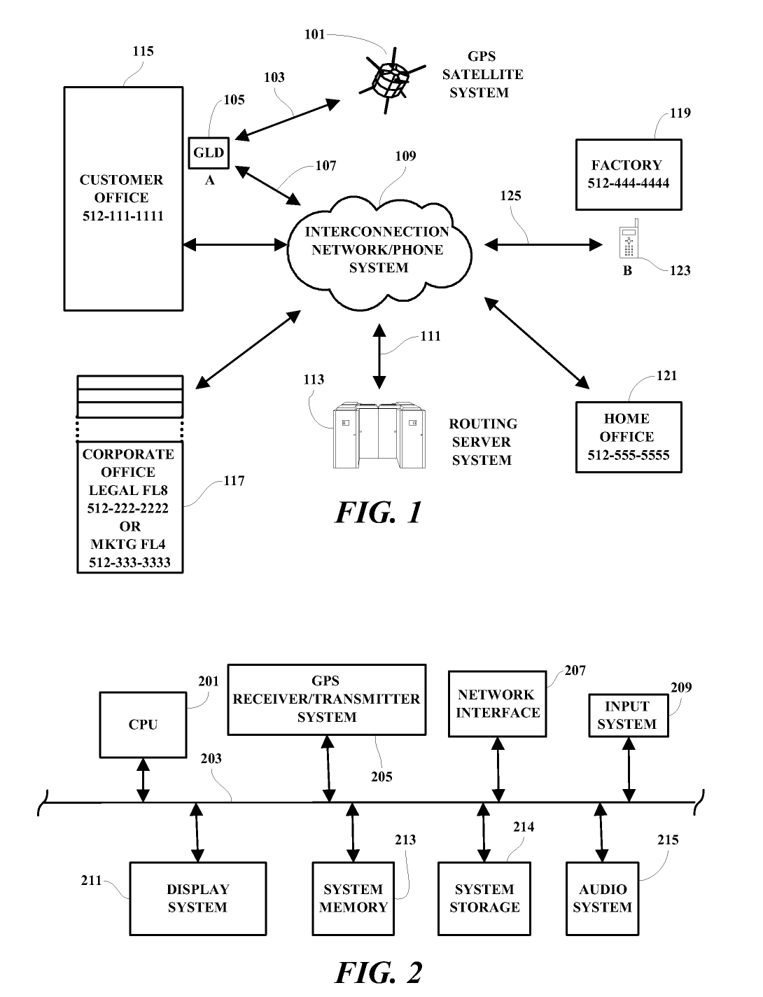

With specific reference to the exemplary embodiments illustrated in the drawings, FIG. 1 shows a GPS satellite system 101, including a series of GPS satellites, positioned to transmit location signals 103 to a mobile geographic locating device (GLD) 105 carried by user A. The mobile device, in the present example, is a mobile telephone equipped with a GPS receiver/transmitter capability to receive position or location signals from the GPS system 101 and transmit those signals 107, representative of the location of mobile device or phone, to a routing server system 113 through an interconnection network 109 and coupling 111. The routing server 113 includes a database containing phone numbers of land-line phones at several locations where the user is likely to be visiting at any given time. For example, as shown in the drawing, a customer office 115 phone number is entered as 512-111-1111, a factory 119 number is 512-444-4444, a home office 121 number is 512-555-5555 and a multi-storied corporate office 117 has a phone number for the Marketing Department on the fourth floor of 512-333-3333 and a phone number for the Legal Department on the eighth floor of 512-222-2222. The server system periodically receives location information for the GPS-enabled device so that at any given time, the server 113 has the coordinates and the altitude of the mobile device. The altitude information is used to determine the floor on which the user is located at any given time. The various facilities are defined in the routing database by geographic coordinates such that when a call is placed to the user A with a first phone number, the server system 113 is able to determine where user A is currently located and whether or not that location is within the specified boundaries of one of the facilities 115, 117, 119, 121 which are listed in a routing database. When the system is enabled by the user, if it is determined that the user is within the coordinates of the customer office 115, incoming calls, for example from user B on mobile phone 123 to a phone number assigned to user A, will be forwarded to the customer office phone 512-111-1111. Similarly, incoming calls will be directed to the factory 119, corporate office 117, home office 121, or other facilities that may be included in the routing database, when a determination is made that the user A is located within the specified coordinates of the corresponding facility. Since altitude information is also maintained at the database, and transmitted from the GPS-enabled device, incoming calls within the coordinates of the corporate office 117 for example, will be routed to either Marketing 512-333-3333 or Legal 512-444-4444, depending upon which floor the GPS-enabled device is located when an incoming call is placed. Note that the corresponding facility may include a mobile phone that is also configured to provide geographic information to the routing server. For example, a mobile phone in possession of a family member or friend of user A may become the phone to route calls to whenever user A is in proximity to the mobile phone.

In FIG. 2, several exemplary components of the location-determining, e.g. GPS-enabled device, are illustrated. As shown, a CPU 201 is connected to a main bus 203. An onboard GPS receiver/transmitter system 205 is also connected to the main bus 203. Other systems are also connected to the main bus 203 including, but not limited to, a network interface 207 for communicating with the server 113, an input system 209 for enabling user input to the system, a display system 211 for displaying, inter alia, routing information and selection and other menus to the user, system memory 213 and system storage 214 from which programming may be accessed and executed, and an audio system 215 for playing audio snippets or files to a user.

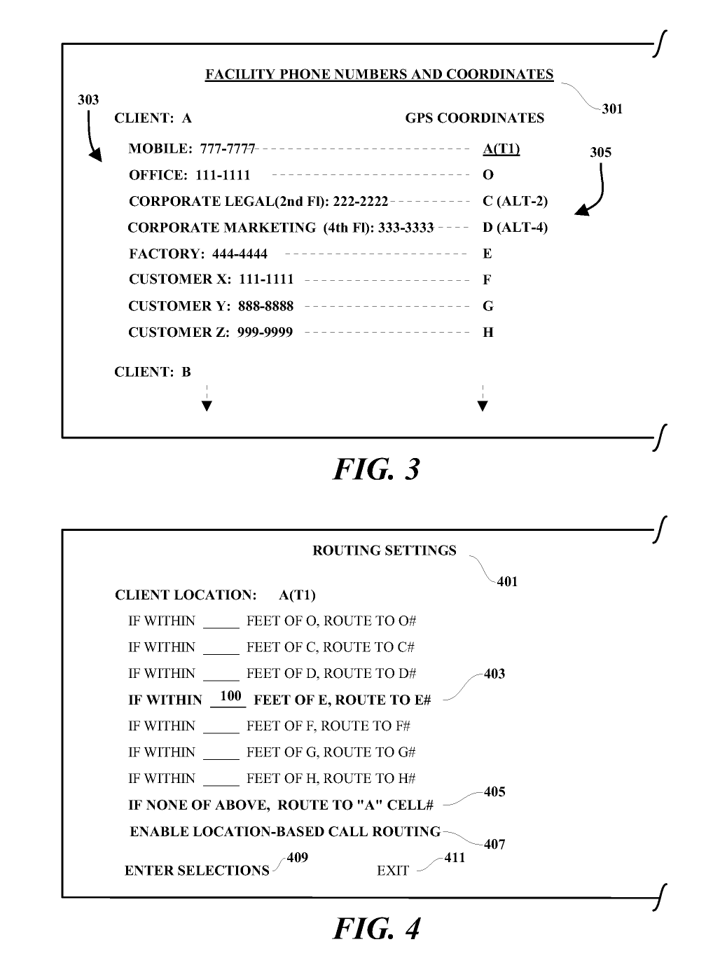

FIG. 3 illustrates a portion of an exemplary server routing database 301 including the phone numbers 303 for various facilities in the user database and also the GPS coordinates 305 for corresponding ones of the facility locations. The GPS coordinates may correspond to a point at which the land-line facility phone is located or the coordinates may define a perimeter around the corresponding facility. The server routing database may include facility coordinates and associated phone numbers for many different clients, e.g. Client A and Client B, etc.

As shown in FIG. 4, in one example, where the facility coordinates define a specific location or “point” within the facility rather than a perimeter, a user may selectively display routing settings 401 by which a user may input and define a radius or distance from the facility reference point such that if the user's GPS-enabled device is detected to be within the input routing radius from the facility reference point, then incoming calls will be directed to the designated land-line phone number. If the current location of the user's GPS-enabled device is not within a designated area or routing radius for one of the facilities listed in the database, then incoming calls will be directed to the user's default phone device, such as a mobile phone, or an answering service instead of one of the designated land-line phones. In the FIG. 4 example, a user has input to the user's routing selections on the user's mobile phone display, a selection indicating that the user wishes to have incoming calls routed to the designated factory phone 403 if the user's GPS-enabled device is detected to be within 100 feet of the GPS coordinates E of the factory phone. Default settings may also be predetermined by the user. For example, a default setting of a 50 feet radius may be set which the user may manually override with a different input to the appropriate input field. In the example, the user has further designated that if the user's GPS-enabled device is not within any of the designated distances from the listed phone numbers, then incoming calls are to be connected 405 to the user's default phone number. The user may also selectively enable or disable the call routing function 407 and/or enter the user settings 409 or exit the application without any changes 411.

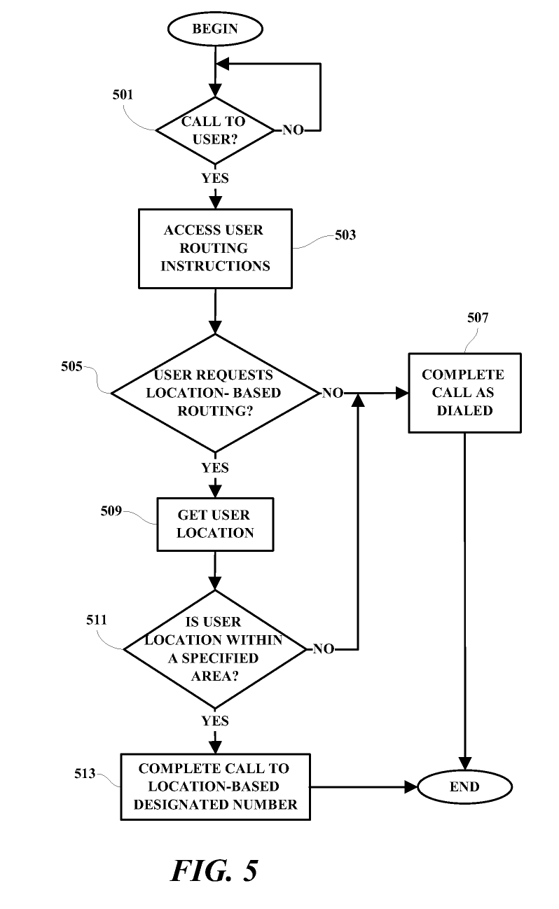

As shown in the FIG. 5 example, when it is detected that a call is being placed 501 to the user A at a first phone number, the user's routing instructions are accessed 503 and it is determined whether or not the user has enabled location-based routing 505 of incoming calls. If location-based routing has not been enabled, then the incoming call is routed 507 to the first phone number as dialed. If, however, the user has enabled location-based routing of incoming calls 505, then the user's current or most recent GPS location is determined 509 and compared with the coordinates for the facilities listed in the user's routing database. If it is determined that the GPS-enabled device is within a designated facility area or with a specified distance from one of the facility land-line phones 511, then the incoming call is forwarded to the appropriate location-based designated land-line phone 513 and the user's location-based call routing process is ended.

In another example, if there is no phone match for the user's location, calls may be routed to non-pre-specified numbers as a default. That is, if a user's GPS location overlaps with a certain street address, then the system will dial the phone associated with that address according to a white pages look-up table. To increase usability factors, the steps for this branch in the logic may include disconnecting if voice mail picks up, and also giving a prerecorded announcement upon live body pick up such as, “Mr. Smith's phone service is attempting to route a call to your phone. Please hang up if Mr. Smith is not nearby or if you do not wish to receive this call. Otherwise, remain on the line and the call will be connected momentarily.” This protocol may be an optional service and with user-configurable blacklists (both for customers of the proxy service and those who have been called by the proxy service). A time filter may also be implemented, e.g. no calls will be placed to listed landlines between 10 PM and 8 AM local time.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including portable or fixed, volatile or non-volatile memory media device, including CDs, RAM and “Flash” memory, or other semiconductor, optical or magnetic memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for routing phone calls directed to a first phone number, said method comprising:
determining when a phone call has been placed directed to said first phone number;
determining a geographic location of a user associated with said first phone number; and
routing said phone call to a second phone number, said second phone number being determined depending upon said geographic location of said user.

2. The method as set forth in claim 1 wherein said geographic location is determined by a GPS-enabled device.

3. The method as set forth in claim 1 and further including accessing a phone routing database in accomplishing said routing.

4. The method as set forth in claim 1 and further including accessing a look-up table in accomplishing said routing.

5. The method as set forth in claim 3 wherein said phone routing database is maintained by a routing server, said routing server being coupled to phone devices associated with the said user through an interconnection network.

6. The method as set forth in claim 5 wherein a geographic location device sends location information descriptive of said geographic location of said user to said routing server, said routing server being operable for updating a record of said geographic location of said user based upon said location information.

7. The method as set forth in claim 1 wherein said routing is selectively enabled and disabled by said user of said first phone number.

8. The method as set forth in claim 1 and further including comparing said geographic location of said geographic location device with a geographic location associated with a phone device, and routing said call to said phone device if said geographic location of said geographic location device is within a predetermined distance from said associated phone device.

9. The method as set forth in claim 8 wherein said predetermined distance is selectively input to said geographic location device by said user of said first phone number.

10. The method as set forth in claim 1 wherein said geographic location device is implemented within a mobile phone device.

11. A storage medium, said storage medium being selectively coupled to processing circuitry, said storage medium containing indicia readable by said processing circuitry for providing program signals for routing phone calls directed to a first phone device having a first phone number, said program signals being effective for:
determining when a phone call has been placed directed to said first phone number;
determining a geographic location of a user associated with said first phone number; and
routing said phone call to a second phone number, said second phone number being determined depending upon said geographic location of said first phone device.

12. The medium as set forth in claim 11 wherein said geographic location is determined by a GPS-enabled device.

13. The medium as set forth in claim 11 wherein said program signals are further effective for accessing a phone routing database in accomplishing said routing.

14. The medium as set forth in claim 13 wherein said phone routing database is maintained by a routing server, said routing server being coupled to phone devices associated with the said user through an interconnection network.

15. The medium as set forth in claim 14 wherein a geographic location device sends location information descriptive of said geographic location of said user to said routing server, said routing server being operable for updating a record of said geographic location of said user based upon said location information.

16. The medium as set forth in claim 11 wherein said routing is selectively enabled and disabled by said user of said first phone number.

17. The medium as set forth in claim 11 wherein said program signals are further effective for comparing said geographic location of said geographic location device with a geographic location associated with a phone device, and routing said call to said phone device if said geographic location of said geographic location device is within a predetermined distance from said associated phone device.

18. The medium as set forth in claim 18 wherein said predetermined distance is selectively input to said geographic location device by said user of said first phone number.

19. The medium as set forth in claim 11 wherein said geographic location device is implemented within a mobile phone device.

20. A system for routing phone calls directed to a first phone number, said system comprising:
means for determining when a phone call has been placed directed to said first phone number;
means for determining a geographic location of a user associated with said first phone number; and
means for routing said phone call to a second phone number, said second phone number being determined depending upon said geographic location of said user.
